(19) United States
(12) Patent Application Publication
(10) Pub. No.: US 2005/0136256 A1
(43) Pub. Date: Jun. 23, 2005

(54) Fiber-reinforced metallic composite material and method

(76) Inventor: Alexei Vichniakov, Bahrendorf (DE)

Correspondence Address: FASSE PATENT ATTORNEYS, P.A., P.O. BOX 726, HAMPDEN, ME, 04444-0726, US

(21) Appl. No.: 11/018,583

(22) Filed: Dec. 20, 2004

(30) Foreign Application Priority Data
Dec. 19, 2003 (DE) 103 60 808.7

(51) Int. Cl. B32B 9/00; C07G 1/00; C08H 1/00; C09K 3/00

(52) U.S. Cl. 428/375; 428/701; 428/702; 428/292.1

(57) ABSTRACT

A fiber composite material which is particularly suitable for aircraft construction, includes anorganic mineral fibers embedded or enclosed in a metal matrix. The mineral fibers include a substantial or dominant proportion of SiO₂, and/or Al₂O₃ and/or Fe₂O₃, the remainder being rock material. The fibers have a length of at least 10 mm and are oriented in parallel to one another in at least one direction. The metal matrix is made of aluminum or aluminum alloys, or of magnesium or magnesium alloys or of titanium or of titanium alloys. These matrix metal alloys contain a substantial or dominant proportion of the respective metal. The fibers are preferably coated with particles of the matrix metal and bonded to one another to form fiber films or fiber sheets which are then laminated between sheets of matrix metal.

### PRIORITY CLAIM

This application is based on and claims the priority under 35 U.S.C. §119 of German Patent Application 103 60 808.7, filed on Dec. 19, 2003, the entire disclosure of which is incorporated herein by reference.

### FIELD OF THE INVENTION

The invention relates to fiber-reinforced composite materials, particularly materials with mineral fibers embedded in a metal matrix. Such composite materials are formed by a method as disclosed herein.

### BACKGROUND INFORMATION

It is known to use relatively long mineral fibers in thermal insulating materials in the construction industry. Primarily basaltic fibers are used for thermal insulating purposes or for reinforcing of concrete products. Such basaltic relatively long fibers are also known to be used for making support plates or substrates for electronic components.

European Patent Publication EP 0,181,996 A2, U.S. Pat. No. 4,615,733, and Russian Patent Publication RU 2,182,605 C1 disclose the use of fiber-reinforced composite materials with a metal matrix. The fibers embedded in the matrix are short and distributed at random. Thus, the orientation of the short fibers relative to each other is also random. The conventionally used short fibers are generally made of a mineral material with substantial proportions of silicon oxide (SiO₂), aluminum oxide (Al₂O₃), and iron oxide (Fe₂O₃). However, conventional fiber-reinforced composite materials with short fibers in a metal matrix do not have the mechanical characteristics required, for example in aircraft construction. Such mechanical characteristics include, for example a substantial tolerance relative to damages, particularly a toughness against crack formations and a resistance against fatigue effects, such as fatigue crack propagation.

In the construction of lightweight structural components emphasis is always on the weight reduction, particularly in the aircraft industry. Moreover, and depending on the respective field of application, such composite materials must meet different requirements with regard to their static and dynamic fatigue characteristics including their tolerance to damages. This requirement applies, particularly in the aircraft construction where lightweight structural components must tolerate damages to avoid failure of the aircraft. An improvement of these damage tolerance characteristics can be achieved in different ways, for example by increasing the skin thickness of an aircraft body or body component. The use of additional locally distributed stiffening components helps increasing the damage tolerance. Adapting the skin thickness in those local positions where stress is largest helps improving the damage tolerance. However, all these measures do not necessarily satisfy weight limitations. Hence, there is a need for a compromise, which particularly in the aircraft industry, is not readily acceptable. Another possibility of increasing the damage tolerance characteristics of such composite materials is the use of materials having inherently better damage tolerance characteristics. Materials having such characteristics are metallic laminates or fiber-reinforced laminates.

Recently, fiber-reinforced composite materials with a metal matrix are achieving an increasing significance because in such materials the fibers permit increasing the strength of metallic materials. More specifically, the damage tolerance characteristics of metallic materials can be significantly increased by reinforcing fibers. However, such an improvement is achieved with noticeably higher costs for such metal based fiber composite materials. One important reason for the higher costs lies in the higher production costs. Particularly, production methods in which the metal matrix is melted onto the fibers, involve a substantial effort and expense with regard to production times and production costs. Such costs have been reduced in a relatively economical production method in which sheet metal layers are bonded to each other by an intermediate adhesive film containing the reinforcing fibers.

In this connection reference is made to European Patent Publication EP 0,312,151 disclosing a laminate comprising at least two sheet metal layers with a synthetic adhesive layer between the sheet metal layers, whereby the adhesive layer bonds the sheet metal layers to each other. The adhesive bonding layer comprises glass filaments. Such laminates are particularly useful for lightweight construction in the aircraft industry because these laminates have advantageous mechanical characteristics while simultaneously having a low structural weight.

European Patent Publication EP 0,056,288 discloses a metal laminate in which polymer fibers are used in the bonding layer. These fibers are selected from the group of aramides, polyaromatic hydrazins, and aromatic polyesters in a synthetic material layer.

European Patent Publication EP 0,573,507 discloses a laminated material in which reinforcing fibers are embedded in a synthetic material matrix. The reinforcing fibers used in EP 0,573,507 are selected from a group of carbon fibers, polyaromatic amide fibers, aluminum oxide fibers, silicone carbide fibers, or mixtures of these components.

The above described sheet metal laminates, if compared with equivalent monolithic sheet metals have the advantages of noticeably higher damage tolerance characteristics. For example, metal laminates reinforced with long fiber bonding layers have crack propagation characteristics that are smaller by a factor of 10 to 20 as compared to respective crack propagation characteristics of monolithic sheet metals. On the other hand, these known laminated materials have frequently static characteristics that are worse than those of monolithic materials. For example, the elastic fatigue limits relative to a tension load or pressure load or a shearing load, are lower by about 5 to 20% compared to respective characteristics of equivalent monolithic materials. The fatigue limits of these known laminated materials depend on the use of the type of the bonding or adhesive system and on the types of fibers used in the system.

Efforts to improve the static characteristics of conventional fiber-composite materials are burdened by higher costs. Conventional manufacturing methods, such as powder metallurgical methods or embedding of fibers in a melted matrix material are very cost sensitive. Moreover, the size of conventional fiber-reinforced composite materials producible by the just-mentioned two methods, are rather limited.

### OBJECTS OF THE INVENTION

In view of the foregoing it is an aim of the invention to achieve the following objects singly or in combination:
to substantially improve the static characteristics of fiber reinforced composite materials having a metal matrix;
more specifically to improve the damage tolerance characteristics while simultaneously achieving a substantial cost reduction compared to conventional production methods of such materials for the same use in the aircraft industry;
to improve the toughness against cracks and the resistance against crack propagation including fatigue crack propagation.

The invention further aims to avoid or overcome the disadvantages of the prior art, and to achieve additional advantages, as apparent from the present specification. The attainment of these objects is, however, not a required limitation of the claimed invention.

### SUMMARY OF THE INVENTION

The above objects have been achieved according to the invention by the combination of the following features in a fiber-composite material comprising a matrix made of a metal selected from a first group comprising aluminum, aluminum alloys, magnesium, magnesium alloys, titanium or titanium alloys, or mixtures thereof. The respective alloys comprise the aluminum or the magnesium or the titanium as a dominant component. Reinforcing anorganic fibers are embedded or enclosed in the metal matrix. The reinforcing anorganic fibers are made of a mineral material that includes at least one additive of any one member of a second group including silicon dioxide (SiO₂), aluminum oxide (Al₂O₃), and iron oxide (Fe₂O₃). The reinforcing anorganic fibers have a length of at least 10 mm and are oriented in parallel to each other in at least one direction.

The present fiber composite materials are produced by orienting the anorganic mineral fibers having a length of at least 10 mm in at least one direction so that the mineral fibers are arranged in parallel to one another, then heating the mineral fibers to at least 200° C., thereby bonding the fibers to one another to form a fiber film and embedding or enclosing said fiber film in the metal matrix which may be formed by sheet metal layers. A plurality of sheet metal layers may be used and bonded to each other by a plurality of fiber films in a laminated structure.

The heating to at least 200° C. is preferably, but not necessarily combined with a pressurization at a pressure of at least 10 MPa. Moreover, the heating, bonding and embedding or inclusion is preferably performed in a vacuum chamber and still more preferably in an inert gas atmosphere, for example in an autoclave or the like. A plurality of mineral fiber films and sheet metal layers may be bonded to one another in a rolling operation to form the fiber composite laminated sheet material. In all instances the sheet metals are made of aluminum, or aluminum alloys, or magnesium, or magnesium alloys, or titanium or titanium alloys or combinations thereof. The aluminum, or the magnesium or the titanium forms a main or dominant component in the respective alloy. The anorganic reinforcing mineral fibers are preferably made of any one or more of the following mineral materials, namely basalt, granite, diabase, amphibolite, diorite, trachyte, porphyry, and obsidian.

The advantage of these mineral materials is seen in their substantial elasticity module within the range of 90 to 120 GPa. Another advantage of these materials is seen in their substantial temperature working range of −260° C. to +640° C. These materials also have good working characteristics when substantial temperature changes or variations occur. Additionally, these materials have a good corrosion resistance. Moreover, the just outlined good characteristics of these anorganic mineral materials remain constant very well in response to vibrations.

### BRIEF DESCRIPTION OF THE DRAWINGS

In order that the invention may be clearly understood, it will now be described in connection with example embodiments thereof, with reference to the accompanying drawings, wherein:

FIG. 1 is a perspective view of a fiber composite material according to the invention prior to compression;

FIG. 2 shows a perspective view of mineral fibers arranged in parallel to one another for bonding to each other;

FIG. 3 illustrates the fibers of FIG. 2 after compression which produces a film of fibers;

FIG. 4 shows a perspective view of two fiber films sandwiched between two outer sheet metal layers, prior to a rolling operation;

FIG. 5 shows a perspective view of four fiber films, whereby in each film the fibers are oriented in parallel to each other and in parallel to all the other fibers in the other fiber films and prior to the application of sheet metal cover layers for example by a compression or rolling operation;

FIG. 6 illustrates two outer fiber films in which the fibers are oriented in parallel to each other in the same direction and an intermediate fiber film in which the fibers are also oriented in parallel to one another, but at a right angle to the fibers in the two outer fiber films and prior to the application of outer sheet metal layers; and

FIG. 7 illustrates a perspective view of a fiber composite material with three fiber films, two outer metal layers, and two inner metal layers forming a laminate.

### DETAILED DESCRIPTION OF A PREFERRED EXAMPLE EMBODIMENT AND OF THE BEST MODE OF THE INVENTION

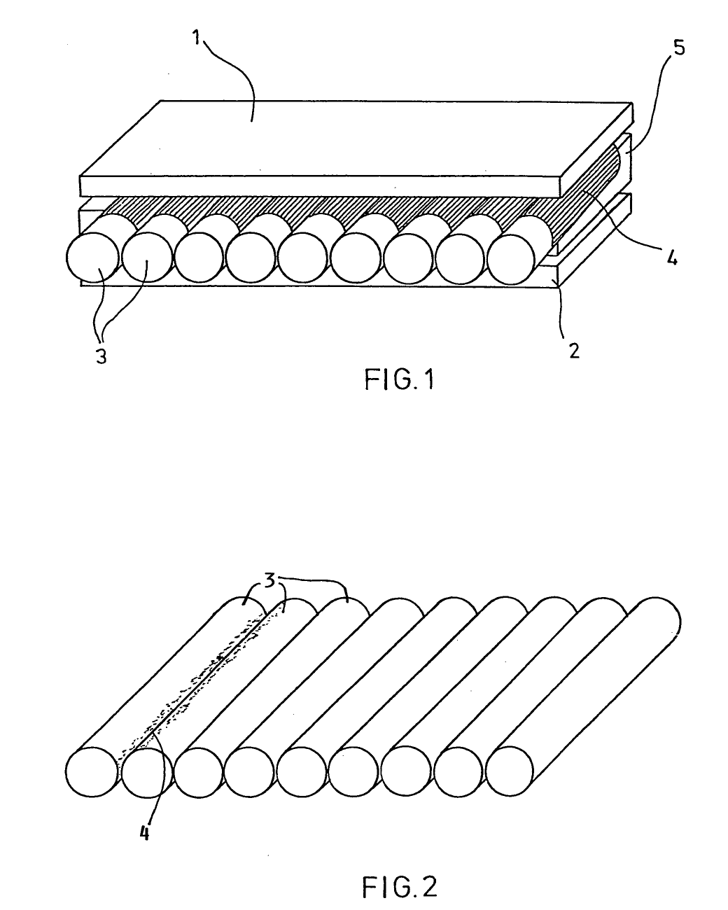

FIG. 1 shows an embodiment of a fiber-reinforced composite material according to the invention including a top cover metal sheet 1 and a bottom cover metal sheet 2 with anorganic mineral fibers 3 sandwiched between the metal cover sheets 1 and 2 which after bonding form the metal matrix. The fibers 3 have a length of at least 10 mm and a coating 4 of particles that adhesively bond the fibers 3 to each other to form a fiber film 5 which in turn bonds the metal layers or cover sheets 1 and 2 to each other. These metal sheets are made for example, of an aluminum alloy of the DIN standard series 5XXX which defines an aluminum magnesium alloy AlMG₂ which forms the metal matrix for the fibers 3.

In another embodiment the matrix material formed by the cover sheets may be made of aluminum copper alloys such as the AA 2024 type or of aluminum zinc alloys such as the AA 7075 type. An aluminum lithium alloy with a lithium content within the range of 0.5 to 3.0% by weight, titanium alloys as well as copper or copper alloys and magnesium alloys are also suitable to form the metal matrix for the present purposes.

The long fibers 3 made of a basaltic material as set forth in the above listing, preferably have a composition as set forth in the following Table of:

Mineral Fiber Example Materials

| Component | Weight % | Preferred wt. % | | Remainder |
|---|---|---|---|---|
| SiO₂ | 35 to 55 | 47 to 50 | | mineral |
| Al₂O₃ | 10 to 25 | 15 to 18 | | material |
| Fe₂O₃ FeO | 7 to 20 | 11 to 14 | | from the |
| MgO | 3 to 12 | 5 to 7 | | above |
| CaO | 5 to 20 | 6 to 12 | {close oversize brace} | listing |
| TiO₂ | 0 to 5 | 1 to 2 | | (any |
| N2O | 0 to 5 | 2 to 3 | | one |
| K20 | 0 to 10 | 2 to 7 | | or more) |

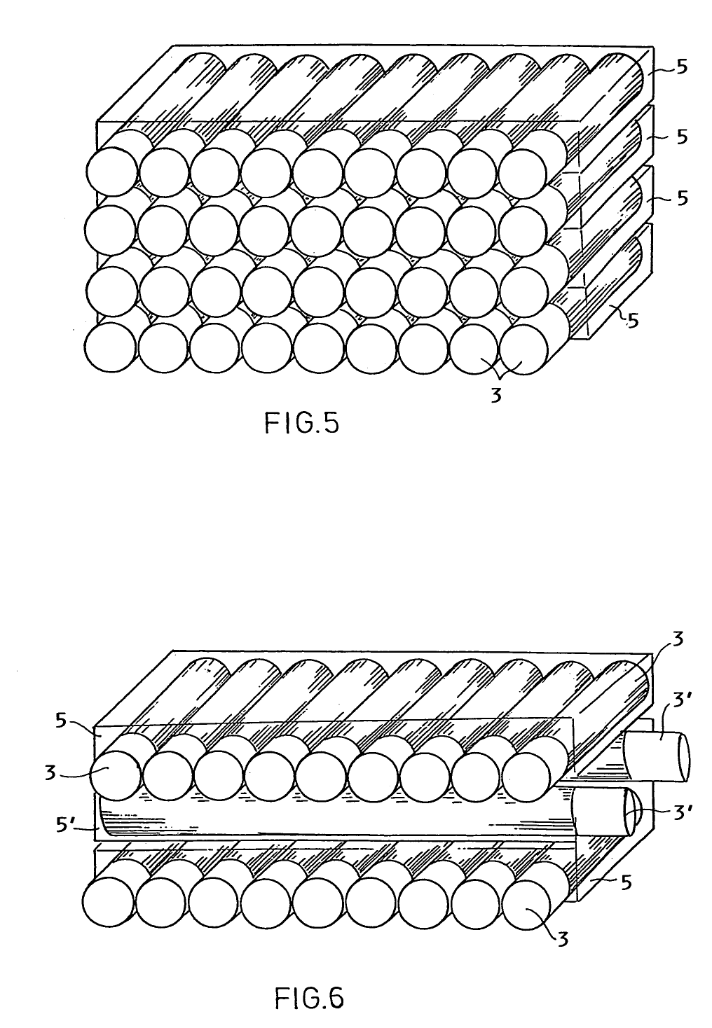

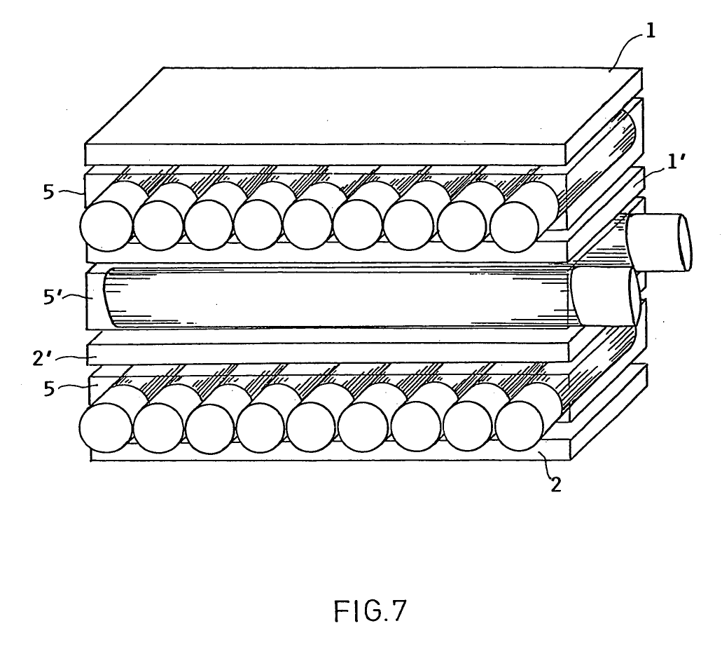

As shown in FIGS. 1, 2, 3, 4 and 5 the long fibers 3 which have a length of at least 10 mm, are oriented in parallel to one another thereby extending in at least one direction. However, the fibers may also be arranged in several plies, whereby the fiber orientation is still in parallel in each ply, but in the manner of a fabric so that the fibers in one ply extend in one direction while the fibers in another ply extend in a crosswise direction as, for example shown in FIGS. 6 and 7. Relative to the total volume of a composite sheet material according to the invention, the fibers occupy preferably a volume portion within the range of about 10 to about 70%. The matrix metal will then occupy a volume within the range of 90 to 30% respectively.

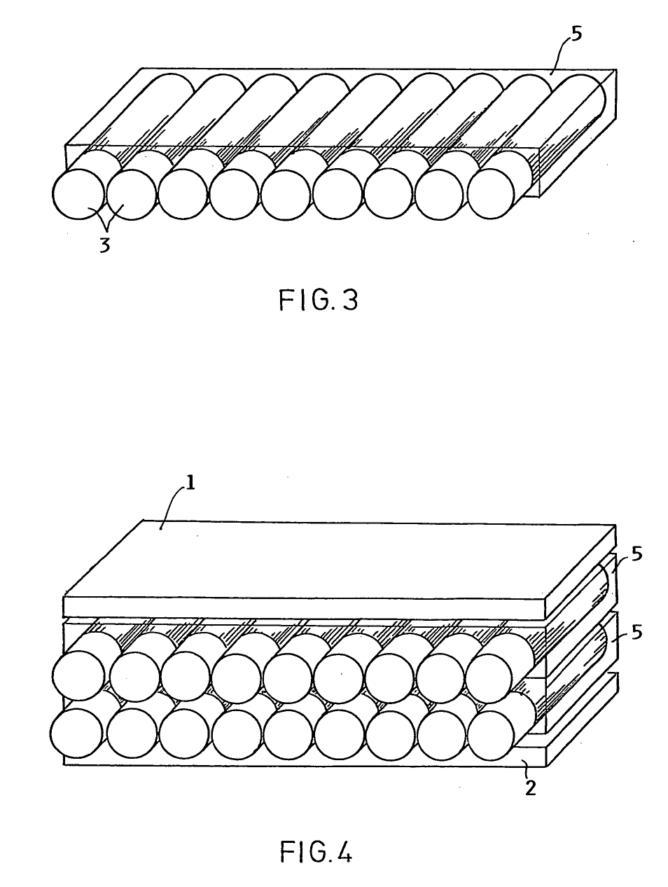

The fibers 3 according to the invention are provided with the particle coating 4 in a thermal operation to enhance the bonding of the fibers to each other as shown in FIG. 2. The coating particles are made of aluminum, magnesium, titanium, or alloys of these metals. The alloys contain the respective metal as a predominant or main component. These fibers as used according to the invention have elongation rupture characteristics that are within the range of 2 to 5% of a standardized length. After aligning the fibers in parallel to one another in at least one direction as shown in FIG. 2, the fibers 3 are all consolidated to form the film or ply 5 of fibers as shown in FIG. 3. The bonding is performed at temperatures in excess of 200° C. and at a pressure of at least, preferably exceeding 10 MPa. Preferably the bonding is performed in a vacuum chamber such as an autoclave containing an inert gas atmosphere.

As shown in FIG. 4 two fiber films 5 are sandwiched between two sheet metal cover layers 1 and 2. These cover layers are made of the metals listed above. The respective alloys contain the metal as a predominant or main proportion. To form a sandwich or laminate, the bonding anorganic mineral layers and the metal layers forming the matrix are exposed to the above mentioned pressure for example in a rolling operation, whereby the gaps between the plies shown in the drawings disappear.

The sheet metal layers 1, 1′ and 2, 2′ preferably have a thickness in the range of 0.01 mm to 3.0 mm.

FIG. 4 shows an embodiment of four fiber films 5 in which all the fibers in each film are oriented in parallel to each other in the same direction in each film. These films after formation are then sandwiched between metal cover layers.

As shown in FIG. 6, the fibers 3 of the upper and lower films or plies 5 are arranged in parallel to one another and in the same direction while the fibers 3′ in the intermediate ply 5′ are oriented at right angles to the orientation direction of the fibers in the plies or films 5 in the upper and lower plies.

FIG. 7 illustrates an embodiment with three plies of fibers, whereby the outer plies 5 have the fibers oriented in the same direction while the fibers in the intermediate ply 5′ are oriented at right angles to the fibers in the outer plies 5 as shown in FIG. 6. Additionally, each ply is sandwiched between two metal plies 1 and 1′; 1′, 2′, and 2 and 2′. Thus, a total of four metal plies are used namely 1, 1′, 2, 2′. The metal plies or layers preferably have a thickness within the range of 0.01 mm to 3.0 mm as mentioned above.

Once the plies are arranged in a laminate, the fiber composite material is subjected to pressure preferably in a rolling operation. The resulting composite material is particular suitable in aircraft construction, more specifically, for aircraft bodies, whereby at least a portion of the body can be made of the present composite materials forming the aircraft skin and/or reinforcements of the aircraft skin.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A fiber composite material comprising a matrix made of a metal selected from a first group comprising any one of aluminum and aluminum alloys, magnesium and magnesium alloys, titanium and titanium alloys, copper and copper alloys, said fiber composite material further including reinforcing anorganic fibers embedded in said metal matrix, said reinforcing anorganic fibers being made of a mineral material and including at least one additive of any one member of a second group of silicone dioxide (SiO₂), aluminum oxide (Al₂O₃) and iron oxide (Fe₂O₃; FeO), said reinforcing anorganic fibers having a length of at least 10 mm and extending in parallel to each other in at least one direction.

2. The fiber composite material of claim 1, wherein said additive further includes any one member of a third group of titanium Oxide (TiO₂), magnesium oxide (MgO), calcium oxide (CaO), nitrous oxide (N₂O) and potassium oxide (K₂O).

3. The fiber composite material of claim 1, wherein said additive silicon oxide (SiO₂) is present in said mineral material within the range of 35 to 55% by weight.

4. The fiber composite material of claim 1, wherein said additive aluminum oxide (Al₂O₃) is present in said mineral material within the range of 10 to 25% by weight.

5. The fiber composite material of claim 1, wherein said additive iron oxide (Fe₂O₃) is present in said mineral material within the range of 7 to 20% by weight.

6. The fiber composite material of claim 2, wherein said additive titanium oxide (TiO₂) is present in said mineral material, in addition to any member of said second group of additives, within the range of 0 to 5% by weight.

7. The fiber composite material of claim 2, wherein said additive magnesium oxide (MgO) is present in said mineral material, in addition to any member of said second group of additives, within the range of 3 to 10% by weight.

8. The fiber composite material of claim 2, wherein said additive calcium oxide (CaO) is present in said mineral material, in addition to any member of said second group of additives within the range of 5 to 20% by weight.

9. The fiber composite material of claim 2, wherein said additive nitrous oxide (N₂O) is present in said mineral material, in addition to any member of said second group of additives, within the range of 0 to 5% by weight.

10. The fiber composite material of claim 2, wherein said additive potassium oxide (K₂O) is present in said mineral material, in addition to any member of said second group of additives, within the range of 0 to 10% by weight.

11. The fiber composite material of claim 2, wherein said metal matrix occupies 30 to 90 percent by volume of said fiber composite material and wherein said reinforcing anorganic fibers occupy 70 to 10 percent by volume of said fiber composite material.

12. The fiber composite material of claim 1, wherein said reinforcing anorganic fibers comprise a coating of particles of any one of aluminum, magnesium, titanium, and alloys of any one of said metals, said coating of particles interconnecting said reinforcing organic fibers.

13. The fiber composite material of claim 1, wherein said reinforcing anorganic fibers form a fabric, said fabric interconnecting said reinforcing anorganic fibers with one another.

14. The fiber composite material of claim 1, wherein said reinforcing anorganic fibers form a film in which said reinforcing anorganic fibers are interconnected by particles of any one of aluminum, magnesium, titanium and alloys of any one of said metals.

15. The fiber composite material of claim 14, comprising a plurality of reinforcing inorganic fiber films and a number of sheet metal layers made of any one of metal of said first group of metals.

16. The fiber composite material of claim 15, wherein said sheet metal layers have a thickness within the range of 0.01 to 3.0 mm.

17. The fiber composite material of claim 14, wherein said reinforcing anorganic fiber films are arranged in said fiber films in different orientations.

18. The fiber composite material of claim 1, wherein said mineral material of which said reinforcing anorganic fibers are made is any one or more of the following mineral materials: basalt, granite, diabase, amphibolite, diorite, trachyte, porphyry and obsidian.

19. A method for manufacturing a fiber composite material having mineral fibers embedded in a metal matrix, said method comprising the following steps:
a) orienting said anorganic mineral fibers having a length of at least 10 mm in at least one direction so that said anorganic mineral fibers are arranged in parallel to one another in said at least one direction,
b) heating said anorganic mineral fibers to at least 200° C. thereby bonding said fibers to one another and forming a fiber film, and
c) embedding said fiber film in said metal matrix.

20. The method of claim 19, further comprising combining said heating with pressurization at a pressure of at least 10 MPa (megapascal).

21. The method of claim 19, further comprising performing said heating, bonding and embedding in a vacuum chamber.

22. The method of claim 19, further comprising performing said heating, bonding and embedding in an inert gas atmosphere.

23. The method of claim 19, further comprising bonding mineral fiber films and sheet metal layers to one another in a rolling operation to form a fiber laminated fiber composite sheet material.

24. An aircraft body comprising a fiber composite material as defined in claim 1 in at least one portion of said aircraft body.

25. The aircraft body of claim 24, wherein said fiber composite material is a reinforcement of said at least one portion of said aircraft body.
